(19) United States
(12) Patent Application Publication
(10) Pub. No.: US 2008/0163104 A1
(43) Pub. Date: Jul. 3, 2008

(54) MULTIPLE WINDOW HANDLER ON DISPLAY SCREEN

(76) Inventor: Tobias HAUG, Heidelberg (DE)

Correspondence Address: KENYON & KENYON LLP, 1500 K STREET N.W., WASHINGTON, DC, 20005, US

(21) Appl. No.: 11/618,825

(22) Filed: Dec. 30, 2006

(51) Int. Cl. G06F 3/048

(52) U.S. Cl. 715/788; 715/823

(57) ABSTRACT

A software method and/or system is provided which may enable a user to handle multiple application windows The user may use this tool to configure and save multiple window views. A user selection interface permits the user to choose a window view among saved view arrangements and, in response the system automatically adjusts the windows' positions and sizes.

### BACKGROUND

With the increased usage of wide screen and high resolution monitors, users are increasingly running multiple applications and viewing the application windows simultaneously. Often, to arrange windows, the user is required to first select a window, position the window, resize the window, and then repeat the process for all remaining windows.

Several drawbacks can exist. A single rearrangement of windows requires multiple time-consuming and tedious steps in order to achieve the desired view. Additionally, once a user creates a desired view for the windows, the user must repeat the process every time the system is restarted and each time windows are closed. It is thus desirable to a create window handier that enables the user to both save preferred window arrangements and repeat the desired window arrangement at a later time. Moreover, a system is needed that permits the user to resize multiple windows in a single action.

It is thus desirable to create systems and methods for streamlining the handling of multiple windows in user interface.

### BRIEF DESCRIPTION OF THE DRAWINGS

FIG. 1 depicts a block diagram of an exemplary system of the present invention.

FIG. 2a illustrates an exemplary interface of the present invention.

FIG. 2b illustrates an exemplary interface of the present invention.

FIG. 3 illustrates an exemplary interface of the present invention.

FIG. 4 illustrates an exemplary interface of the present invention.

FIG. 5a illustrates an exemplary interface of the present invention.

FIG. 5b illustrates an exemplary interface of the present invention.

FIG. 6. illustrates a flowchart of illustrative steps of an exemplary method of the present invention.

FIG. 7 illustrates a flowchart of illustrative steps of an exemplary method of the present invention.

### DETAILED DESCRIPTION

Embodiments of the present invention provide a computer user interface tool for use in computer applications through which operators may handle multiple application windows.

Embodiments of the present invention provide systems and methods that permit a user to update multiple window arrangements through a shortcut keyboard combination or mouse selection.

To tile all active windows horizontally with the windows spaced equally apart, the user may define a shortcut keyboard combination such as the “F-12” key or the “Control-1” key combination. The user may alternatively use the computer's pointing device and select an arrangement from a view arrangement icon located in the system tool bar by double clicking to scroll through different view arrangements, or by right clicking and choosing a “Select View” option.

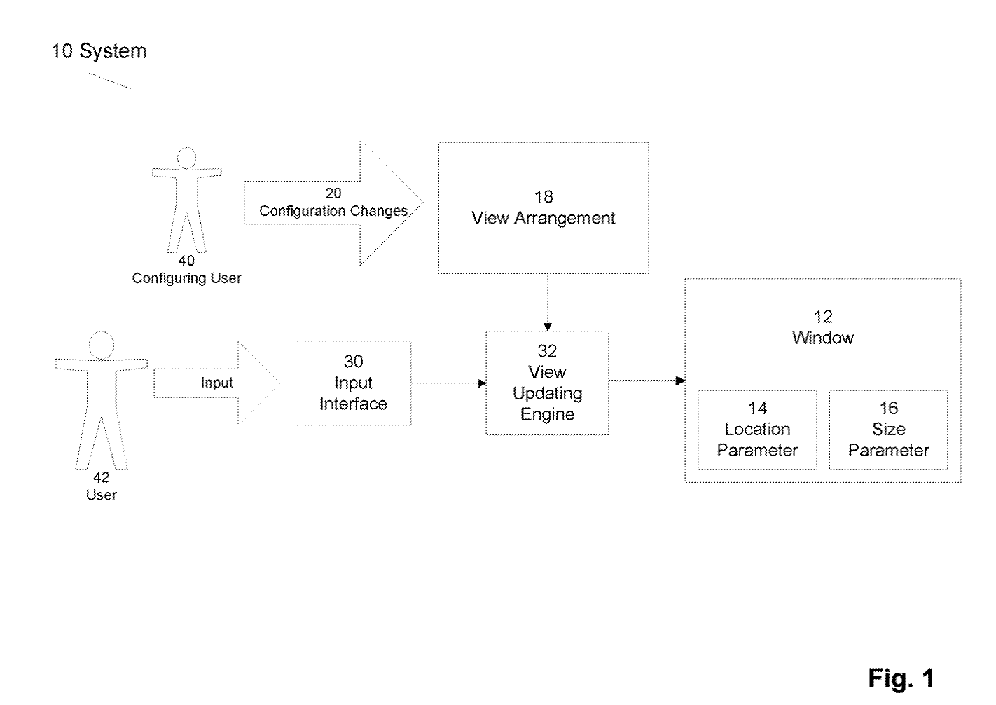

FIG. 1 depicts an exemplary system 10 of the present invention including a window 12, a view arrangement 18, an input interface 30 and a view updating engine 32. The window 12 contains a location parameter 14 and a size parameter 16. When a new view is selected via the input interface 30, the view updating engine 32 updates the location parameter 14 and the size parameter 16. The view arrangement 18 may contain pre-defined default views, or those default rules may be redefined or additional views may be added by making configuration changes 20 to the view arrangement 18.

By updating the location parameter 14 and size parameter 16 for a window, the windowing manager of an operating system will display the window in a new location on the screen with a new size.

In one embodiment, particular views may be user-defined and assigned to keyboard shortcuts or customizable computer pointing device selections. These user-defined keyboard shortcuts or computer pointing device selections and their associated window view arrangements can be saved, permitting the user to recall previously saved view arrangements for later use.

By allowing changes to the view arrangement 18 to be updated at run time, the system may be customized to the particular users who will use the system. This feature may make multiple window handling more user friendly and compatible with styles of users in various situations. For example, users of several word processing applications may prefer to have a horizontally tiled view arrangement, whereas users of multiple spreadsheet applications may prefer to have a vertically tiled view arrangement. Such a vertically tiled spreadsheet arrangement might display the top spreadsheet occupying 75% of the window space on the screen because that window is the one being currently edited, whereas the bottom window or windows might occupy the remaining 25% of the space, because only particular rows need to be seen.

View arrangement 18 contains the rules for updating the location parameter 14 and size parameter 16 of window 12. In one embodiment, a windowing manager may record a window position and size by having a separate field for the upper left hand corner location, a separate field for the length and a separate field for the height of the window. The view arrangement 18 in this example might contain rules to update the upper left hand corner location information, the length information and the height information for each window being updated. Alternatively, a window manager may record a window position and size by having a separate field for the upper left hard corner information, a separate field for the upper right hand corner location information, a separate field for the lower left hand corner information and a separate field for the lower right hand corner information. In this case, the view arrangement 18 may contain rules to update the upper left hand corner information, the upper right hand corner information, the lower left hand corner information and the lower right hand corner information for each window being updated.

The configuration changes 20 may also be prompted by a user resizing one of the active windows shown. For example, we may have three active windows shown on a screen, horizontally tiled with each window having equal length, and the user resizes the width of the leftmost window by clicking on the right edge of the leftmost window and dragging with the computer's pointing device leftwards to reduce the width of the leftmost window. The view arrangement 18 may contain rules for updating the size of the middle window or the rightmost window in response. The width of the middle window may increase by an amount equal to the amount the width of the leftmost window decreased by. Alternatively, the widths of the middle and rightmost windows may each increase by half of the width decreased by the leftmost window, resulting in the middle and rightmost windows maintaining equal widths.

In another embodiment, the configuring user, who is responsible for updating the view arrangement, and the user who selects the view arrangement may be the same person. In this way, a user who uses the system may customize the way that the system may arrange the views to best suit the user's particular style.

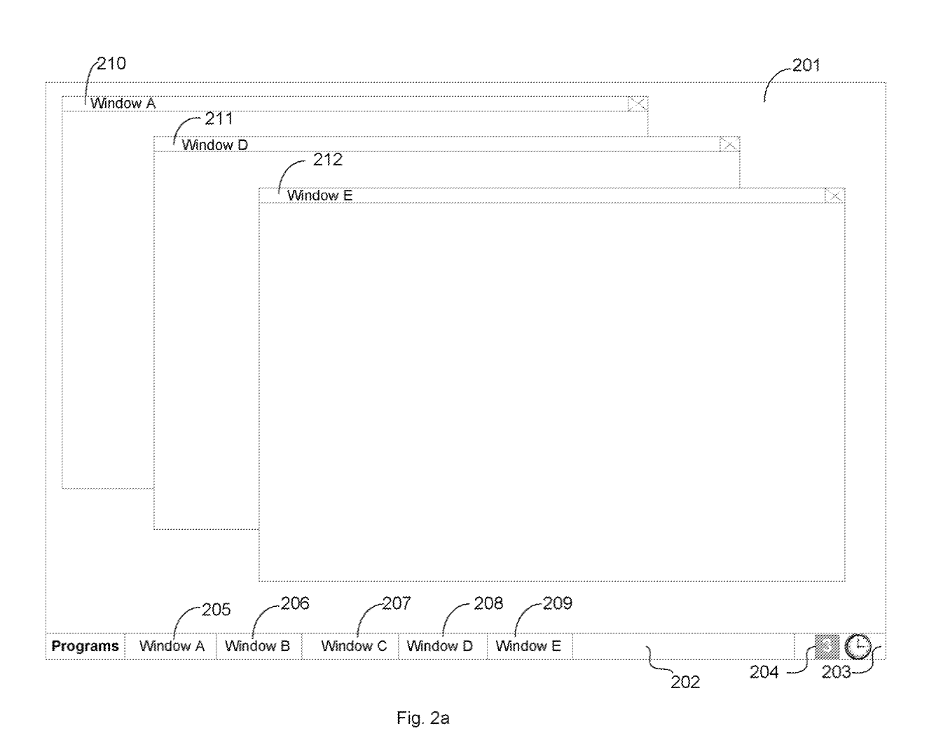

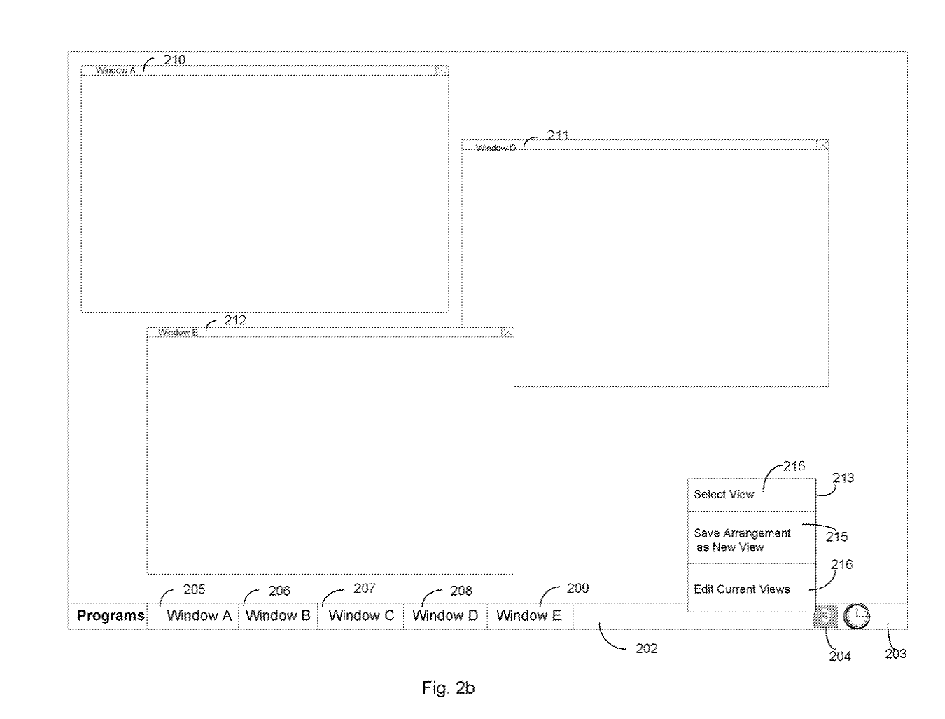

The view arrangement 18 may present an interface for selecting or making changes to the views. In one embodiment, the interface may be implemented as shown in FIGS. 2a and 2b. FIG. 2a depicts an interface that may permit a user to update the view. The user may have multiple user application windows running in a graphical user interface 201, and display each in the system task bar 202 as a separate button, such as Window A button 205, Window B button 206, Window C button 207, Window D button 208 and Window E button 209. One or more user application may be active, and one or more may be inactive or minimized. In FIG. 2a, application Window A 210, application Window D 211 and application Window E 212 are active, while application Window B (not shown) and application Window C (not shown) are inactive, represented only by Window B button 206 and Window C button 207. The user may minimize or make inactive an application if it is currently active by clicking on the button that represents that application. Likewise, the user may restore or make active an inactive application window by clicking on the button that represents that application. System tray 203 may contain one or more system tray icons. In one embodiment the view arrangement 18 may present a system tray icon 204 that displays a number corresponding to a particular view. In this case, the system tray icon 204 shows a number “3” representing the third view selectable. The user might alternate between views by clicking or double-licking on the system tray icon 204.

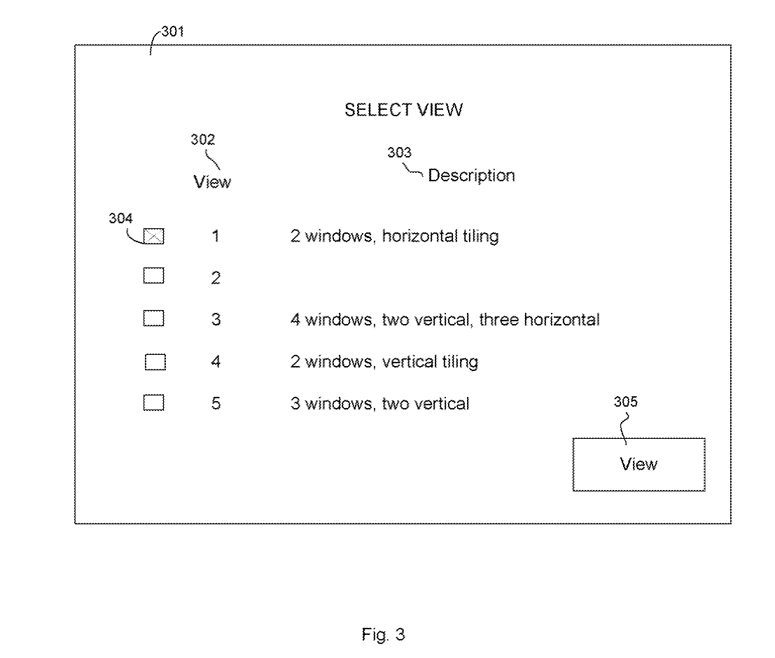

In another embodiment, the user may be able to right click on the system tray icon 204 shown in FIG. 2a and a menu 213 as shown in FIG. 2b may appear on the screen. Options in the menu might include “Select View” 214 “Save Arrangement as New View” 215 and “Edit Current Views” 216. Clicking on the option “Select View” 214 might bring up a pop-up window 301 as shown in FIG. 3. In pop-up window 301, there may be a column “View” 302 with numbers corresponding to the view numbers shown in the system tray icon 204. In pop-up window 301 there may also be a column “Description” 303 with user entered descriptions of what each view number in column “View” 302 represents. If the user never entered a description, the description field may be blank. Option selection checkboxes 304 might show an “X” in the checkbox of the view currently active. If the user wishes to select an alternative view, the user may use click a different checkbox with the user's computer pointing device, which would place an “X” in the newly selected checkbox and remove the “X” in the previously selected checkbox. To activate the newly selected view, the user may click on the “View” button 305, which would remove the pop-up window 301 and show the updated view.

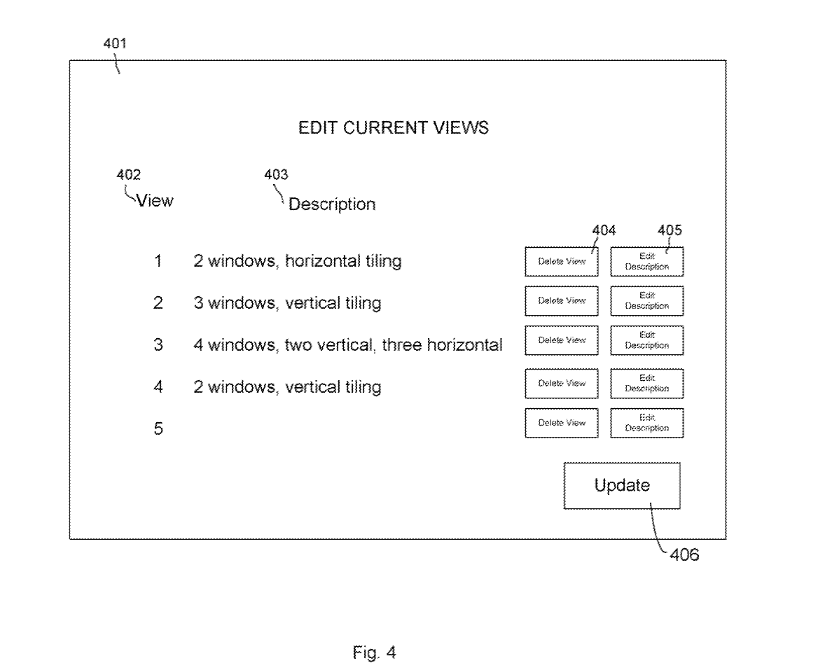

In another embodiment, the user selects “Edit Current Views” 216 from menu 213 as shown in FIG. 2b. This can bring up a pop-up window 401 as shown in FIG. 4 allowing the user to edit the currently available views. The pop-up window 401 may include a column “View” 402 with numbers corresponding to the view numbers shown in the system tray icon 204. In pop-up window 401, there may also be a column “Description” 403 with user entered descriptions of what each view number in column “View” 402 represents. If the user never entered a description, the description field may be blank. A user might click on button “Delete View” 404 of a particular row to delete a particular view. A user might click on button “Edit Description” 405 to edit the description field of that row. When a user has completed all changes, the user might click on the button “Update” 406 to continue and remove the pop-up window 401.

In yet another embodiment, application windows in a system might appear on the screen in a cascaded fashion as shown in FIG. 2a. By clicking on the system tray icon 204, the view might be updated to show the view arrangement “3” and change the window locations and sizes for all the active windows, resulting in the display shown in FIG. 2b.

In another example, a user might move around the windows of FIG. 2a currently active windows and resize them, and wish to save them to a new view. The user might move and resize the windows, which may result in the view as shown in FIG. 2b. To save the view, the user might right click on system tray icon 204 to bring up menu 213 and select “Save Arrangement as New View” 215, which might save the currently shown view as the next incremental view number.

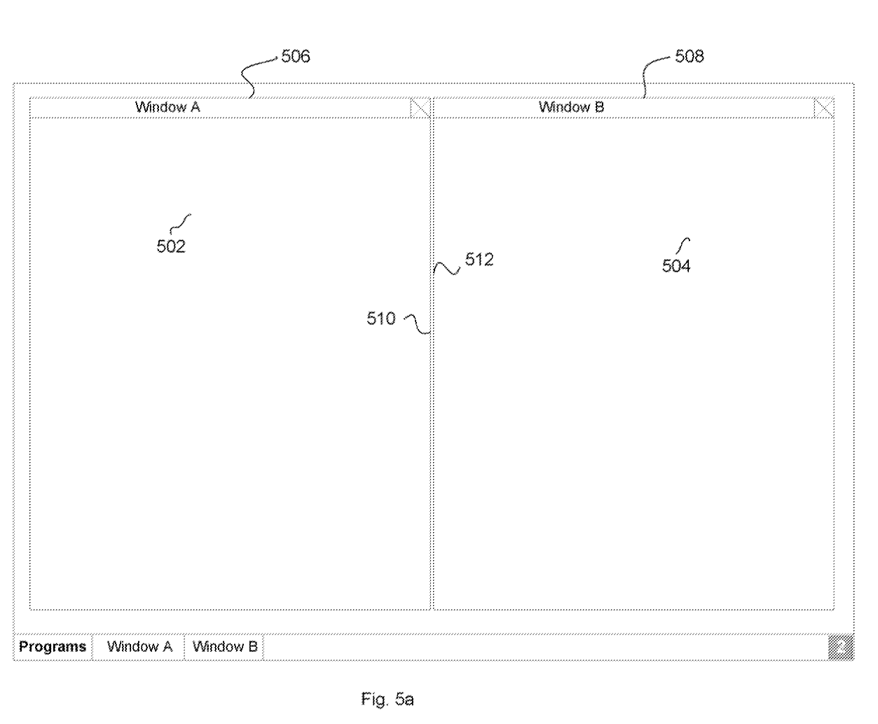

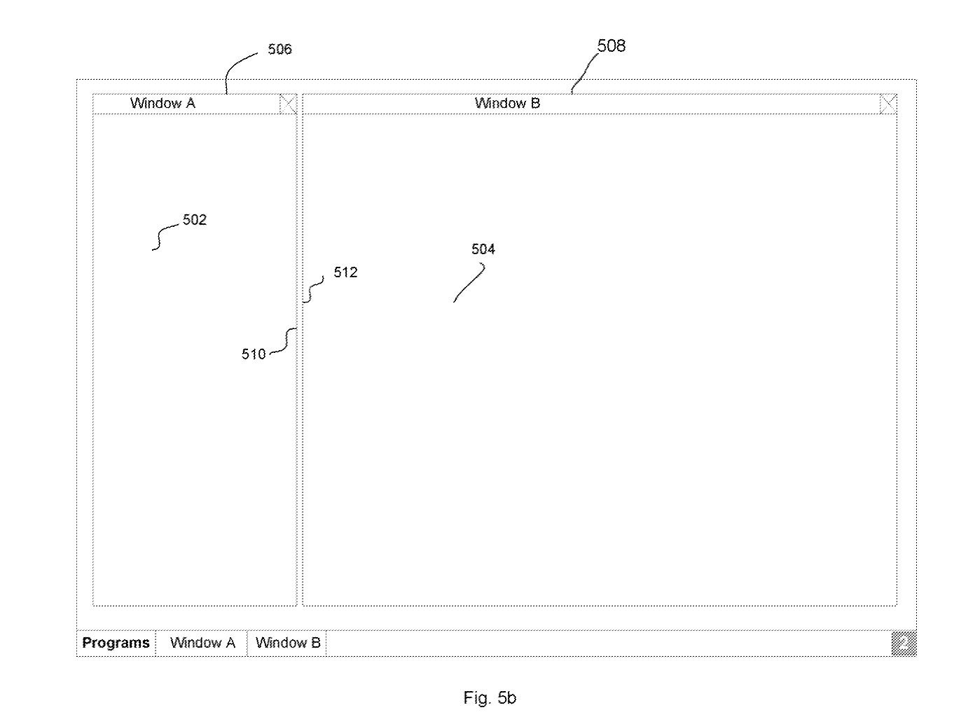

FIGS. 5a and 5b illustrate an exemplary interface of the multiple window handler. FIG. 5a illustrates an interface displaying two windows, Window A 502 and Window B 504, horizontally tiled. In FIG. 5a, the Window A top edge 506 and the Window B 508 top edge are approximately equal in length and each covers approximately half of the horizontal length available for viewing windows. In this embodiment, the user may select the Window A right edge 510 or the adjacent Window B left edge 512 by pointing and clicking the computer pointing device at either edge. Upon selecting the adjacent Window A right edge 510 or the adjacent Window B left edge 512, the user may slide the edge left or right, using the pointing device, to make the window selected have either a shorter top edge length, depending on the direction the selected side edge is moved. As the selected edge is moved left or right in order to increase or decrease the top edge length of the selected window, the top edge length of the other window increases or decreases in inverse proportion to the selected window. When the user releases the pointing device, the sizes of the windows are fixed until the user initiates another window arrangement configuration.

FIG. 5b illustrates an interface resulting from a user selecting either the Window A right edge 510 or the adjacent Window B 512 left edge and sliding the selected edge left and releasing the pointing device where the selected edge is displayed in the interface. The Window B top edge 506 is longer than Window A top edge 506.

In another embodiment, the interface may contain greater than two windows. In yet another embodiment of the multiple window handler may contain rules for arranging windows arranged in vertical tile format, horizontal format, as illustrated in FIGS. 5a and 5b, or a combination of horizontally and vertically tiled windows.

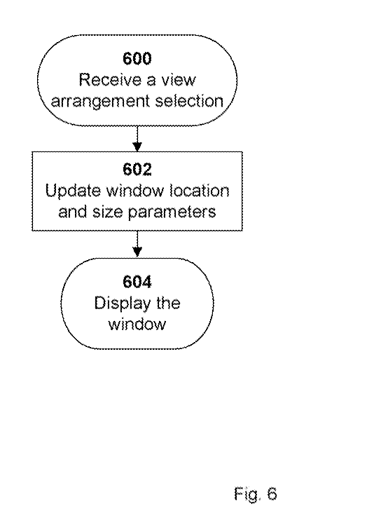

Exemplary steps of the present invention are depicted in FIG. 6. The system may receive a view arrangement selection from a user. In response to the view arrangement selection, the system may update the window location and size parameters for the active windows on the screen. As a result of the updated parameters, the window manager may display the updated location and sizes.

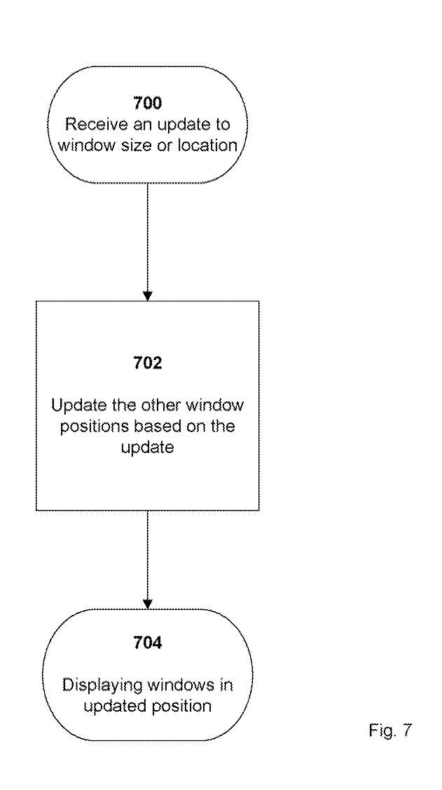

Exemplary steps of the present invention are depicted in FIG. 7. The system may receive an update to a window size or location as a result of the user resizing or moving the window. In response, the system may update the other window positions. The window manager may, as a result of the updates display the windows in updated positions.

Several embodiments of the present invention are specifically illustrated and described herein. However, it will be appreciated that modifications and variations of the present invention are covered by the above teachings and within the purview of the claims without departing from the spirit and intended scope of the invention,

What is claimed is:

1. A user interface system comprising:
at least two application windows, each window having a location parameter and a size parameter;
at least one view arrangement;
a user interface for selecting the at least one view arrangement; and
a view engine for updating the location parameter and the size parameter of each window based on the selected at least one view arrangement,
wherein the at least one view arrangement includes rules for changing the location parameter and the size parameter of each window.

2. The system of claim 1, wherein the user interface receives user input via a keyboard shortcut.

3. The system of claim 2, wherein the keyboard shortcut is user-defined.

4. The system of claim 3, wherein the user-defined keyboard shortcut and the at least one view arrangement are recorded in a memory.

5. The system of claim 1, wherein the user interface receives user input via a computer pointing device selection.

6. The system of claim 5, wherein the computer pointing device selection is user-defined.

7. The system of claim 6, wherein the computer pointing device selection and the at least one view arrangement are recorded in a memory,

8. A user interface method comprising:
providing at least one application window, the window comprising a location parameter and a size parameter;
providing at least one view arrangement;
receiving one view arrangement selection;
updating the location parameter and the size parameter based on the view arrangement;
displaying the at least one window.

9. A user interface method comprising:
providing a first application window, the first application window having a first location parameter and a first size parameter;
providing at least one additional application window, the at least one additional application window having a respective additional location parameter and additional size parameter;
receiving an update to the first location parameter and the first size parameter;
updating the respective additional location parameter and the respective additional size parameter in response to the updated first location parameter and the updated first size parameter; and
displaying the first application window and the at least one additional application window with the resulting location and size.
